(19) United States
(12) Patent Application Publication
(10) Pub. No.: US 2016/0278019 A1
(43) Pub. Date: Sep. 22, 2016

(54) APPARATUS AND METHOD FOR CONTROLLING THE GENERATION OF A RADIO FREQUENCY TRANSMIT SIGNAL

(71) Applicant: Intel IP Corporation, Santa Clara, CA (US)

(72) Inventors: Andreas Langer, Lohhof (DE); Hans Henningsen, Blokhus (DK)

(21) Appl. No.: 15/043,764

(22) Filed: Feb. 15, 2016

(30) Foreign Application Priority Data
Mar. 16, 2015 (DE) 10 2015 103 807.2

(51) Int. Cl. H04W 52/04

(52) U.S. Cl. CPC H04W 52/04

(57) ABSTRACT

An apparatus for controlling the generation of a radio frequency transmit signal includes a control module configured to control at least one power amplifier stimulus of a power amplifier module based on information related to at least one intermodulation product caused during generation of an amplified radio frequency transmit signal amplified by the power amplifier module. The amplified radio frequency transmit signal has at least two spectral clusters allocated for data transmission.

### CROSS REFERENCE TO RELATED APPLICATIONS

This application claims priority to German Application number 10 2015 103 807.2, filed on Mar. 16, 2015, the contents of which are herein incorporated by reference in its entirety.

### FIELD

The present disclosure relates to wireless communication concepts and in particular to an apparatus and a method for controlling the generation of a radio frequency transmit signal.

### BACKGROUND

The demand on ever increasing amount of data to be transmitted in short time causes higher requirements with respect to the transmit signals. Therefore, it is desired to improve the control over disturbances and interferences within transmit signals to meet desired limits.

### BRIEF DESCRIPTION OF THE DRAWINGS

Some examples of apparatuses and/or methods will be described in the following by way of example only, and with reference to the accompanying figures, in which

FIG. 1 shows a schematic illustration of an apparatus for controlling the generation of a radio frequency transmit signal;

FIG. 2 shows a schematic illustration of a transmitter or transceiver with an apparatus for controlling the generation of a radio frequency transmit signal;

FIG. 3 shows a schematic illustration of an apparatus for controlling the generation of a radio frequency transmit signal;

FIG. 4 shows a block diagram of a mobile device;

FIG. 5 shows a flow chart of a method for controlling the generation of a radio frequency transmit signal;

FIG. 6 shows a flow chart of a method for controlling the generation of a radio frequency transmit signal; and

FIG. 7 shows a schematic illustration of a multi-cluster signal and a corresponding 3^{rd} order intermodulation IM3 spectrum.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while examples are capable of various modifications and alternative forms, the illustrative examples in the figures and will herein be described in detail. It should be understood, however, that there is no intent to limit examples to the particular forms disclosed, but on the contrary, examples are to cover all modifications, equivalents, and alternatives falling within the scope of the disclosure. Like numbers refer to like or similar elements throughout the description of the figures.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing illustrative examples only and is not intended to be limiting. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or component signals, but do not preclude the presence or addition of one or more other features, integers, steps, operations, elements, component signals and/or groups thereof.

Unless otherwise defined, all terms (including technical and scientific terms) used herein have the same meaning as commonly understood by one of ordinary skill in the art to which examples belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

In the following, various examples relate to devices (e.g. cell phone, base station) or components (e.g. transmitter, transceiver) of devices used in wireless or mobile communications systems. A mobile communication system may, for example, correspond to one of the mobile communication systems standardized by the 3rd Generation Partnership Project (3GPP), e.g. Global System for Mobile Communications (GSM), Enhanced Data rates for GSM Evolution (EDGE), GSM EDGE Radio Access Network (GERAN), High Speed Packet Access (HSPA), Universal Terrestrial Radio Access Network (UTRAN) or Evolved UTRAN (E-UTRAN), Long Term Evolution (LTE) or LTE-Advanced (LTE-A), or mobile communication systems with different standards, e.g. Worldwide Interoperability for Microwave Access (WIMAX) IEEE 802.16 or Wireless Local Area Network (WLAN) IEEE 802.11, generally any system based on Time Division Multiple Access (TDMA), Frequency Division Multiple Access (FDMA), Orthogonal Frequency Division Multiple Access (OFDMA), Code Division Multiple Access (CDMA), etc. The terms mobile communication system and mobile communication network may be used synonymously.

The mobile communication system may comprise a plurality of transmission points or base station transceivers operable to communicate radio signals with a mobile transceiver. In these examples, the mobile communication system may comprise mobile transceivers, relay station transceivers and base station transceivers. The relay station transceivers and base station transceivers can be composed of one or more central units and one or more remote units.

A mobile transceiver or mobile device may correspond to a smartphone, a cell phone, User Equipment (UE), a laptop, a notebook, a personal computer, a Personal Digital Assistant (PDA), a Universal Serial Bus (USB)-stick, a tablet computer, a car, etc. A mobile transceiver or terminal may also be referred to as UE or user in line with the 3GPP terminology. A base station transceiver can be located in the fixed or stationary part of the network or system. A base station transceiver may correspond to a remote radio head, a transmission point, an access point, a macro cell, a small cell, a micro cell, a pico cell, a femto cell, a metro cell etc. The term small cell may refer to any cell smaller than a macro cell, i.e. a micro cell, a pico cell, a femto cell, or a metro cell. Moreover, a femto cell is considered smaller than a pico cell, which is considered smaller than a micro cell. A base station transceiver can be a wireless interface of a wired network, which enables transmission and reception of radio signals to a UE, mobile transceiver or relay transceiver. Such a radio signal may comply with radio signals as, for example, standardized by 3GPP or, generally, in line with one or more of the above listed systems. Thus, a base station transceiver may correspond to a NodeB, an eNodeB, a BTS, an access point, etc. A relay station transceiver may correspond to an intermediate network node in the communication path between a base station transceiver and a mobile station transceiver. A relay station transceiver may forward a signal received from a mobile transceiver to a base station transceiver, signals received from the base station transceiver to the mobile station transceiver, respectively.

The mobile communication system may be cellular. The term cell refers to a coverage area of radio services provided by a transmission point, a remote unit, a remote head, a remote radio head, a base station transceiver, relay transceiver or a NodeB, an eNodeB, respectively. The terms cell and base station transceiver may be used synonymously. In some examples a cell may correspond to a sector. For example, sectors can be achieved using sector antennas, which provide a characteristic for covering an angular section around a base station transceiver or remote unit. In some examples, a base station transceiver or remote unit may, for example, operate three or six cells covering sectors of 120° (in case of three cells), 60° (in case of six cells) respectively. Likewise a relay transceiver may establish one or more cells in its coverage area. A mobile transceiver can be registered or associated with at least one cell, i.e. it can be associated to a cell such that data can be exchanged between the network and the mobile in the coverage area of the associated cell using a dedicated channel, link or connection. A mobile transceiver may hence register or be associated with a relay station or base station transceiver directly or indirectly, where an indirect registration or association may be through one or more relay transceivers.

For example, LTE Advanced (LTE-A) is an evolutionary path from LTE Release 8 and was introduced by Release 10 of 3GPP standardization. A new major feature of Rel-10 is carrier aggregation (CA). To achieve higher data rates two or more component carriers (CC) can be aggregated to support a transmission bandwidth up to 100 MHz. However initial LTE-A deployments may be limited to two component carriers which means a maximum bandwidth of 40 MHz. There are different scenarios to realize CA: inter-band or intra-band CA, contiguous or non-contiguous carrier aggregation, contiguous or non-contiguous RB (resource block) allocation within the CC channel bandwidth.

Other new features are MC-PUSCH (multi-cluster PUSCH physical uplink shared channel) and simultaneous PUSCH-PUCCH (physical uplink control channel) transmission, for example. Here the relevant characteristic may be the non-contiguous RB allocation. This means that the transmission spectrum is no longer contiguous over frequency. The spectrum is segmented in clusters. The cluster size and the gap between the clusters depend on the channel configuration.

Due to multi cluster transmission the single carrier property of single-carrier SC-FDMA (LTE uplink modulation scheme) may be no longer preserved which results in a higher peak-to-average ratio of the signal. The impact on the peak-to-average ratio (PAR) may be different for MC-PUSCH and for intra-band carrier aggregation. MC-PUSCH may result in a minor increase of peak-to-average ratio since the spectral clusters are derived from the spectrum of a single data stream. In contrast intra-band CA may cause a clearly increased PAR since the aggregated spectrum consists of spectrum contributions from independent data streams (=superposition of independent signals).

For example, a challenge is the higher power density associated with small clusters. Total transmit power may be distributed on multiple clusters (in extreme case multiple clusters with one or a few RBs) which causes the higher power density as shown in FIG. 7.

Multiple clusters with high cluster power levels may cause intermodulation products (3^{rd} order, 5^{th} order or higher order) which may be also clustered and feature a high power. Thus intermodulation effects may be a key issue when dealing with multi-cluster signals.

Intermodulation effects may be harmful for adjacent channel leakage ratio ACLR (e.g. UTRA2), spectrum emissions mask (SEM), spur emissions and noise in RX band. The dedicated issues may be highlighted by focusing on UTRA2 as an example. UTRA2 limit is −36 dBc. The UTRA2 window is inside the 3/2x BW_channel_agg range defined by 3GPP. A highly critical case may be two clusters with a single RB allocation in each cluster. This may give highest power density. The IM3 (3rd order intermodulation) power may be spread over 3 RBs and may be fully captured by the 3.84 MHz measurement filter as defined by 3GPP. The spacing between the two clusters can be such selected that the IM3 power hits the UTRA2 3.84 MHz window. This may give worst case UTRA2 performance and may be clearly worse compared to a traditional continuous spectrum. Same mechanism may be harmful for SEM, spur emissions and noise in RX band since the power be completely or mostly captured by the measurement filter bandwidth associated with the 3GPP test case.

Therefore, the transmission of a multi cluster signal may be a crucial issue and a problem for mobile terminals.

Rel-10 specifies various MPR (=Maximum Power Reduction) figures which allow a reduction of the maximum total output power depending on the cluster sizes. However, this MPR figure does not differentiate if the intermodulation might be harmful (e.g. for SEM, ACLR, spur emissions) or not, for example. Each power reduction may compromise the data throughput and other QoS figures.

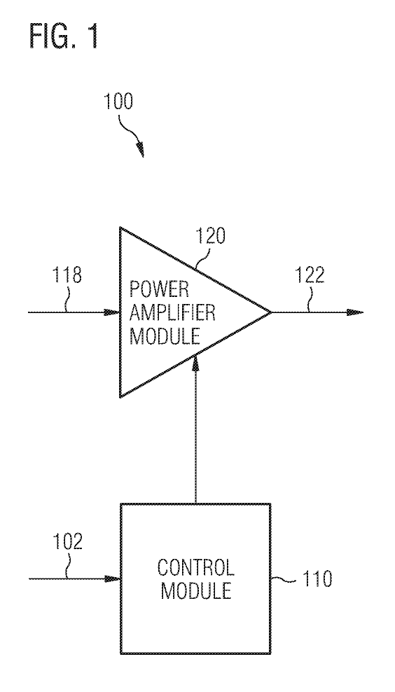

FIG. 1 shows a block diagram of an apparatus for controlling the generation of a radio frequency transmit signal according to an example. The apparatus 100 includes a control module 110 controlling at least one power amplifier stimulus of a power amplifier module 120 based on information related to at least one intermodulation product 102 caused during generation of an amplified radio frequency transmit signal 122 amplified by the power amplifier module 120. The amplified radio frequency transmit signal 122 has at least two spectral clusters allocated for data transmission.

The linearity and/or output power of the power amplifier module may be varied by adapting a power amplifier stimulus of the power amplifier module, for example. In this way, the magnitude of intermodulation products within RF transmit signals may be controlled. Further, predefined spectral limits (e.g. of a wireless communication standard) may be kept easier and/or more accurate. Further, the current consumption or data throughput may be improved.

The power amplifier module 120 may amplify a radio frequency transmit signal 118 provided by a radio frequency generation module to generate the amplified radio frequency transmit signal 122. The power amplifier module 120 may provide the amplified radio frequency transmit signal 122 to an antenna module (e.g. comprising matching network, antenna switch and/or one or more antennas) for transmission of the amplified radio frequency transmit signal 122 to an external receiver. The power amplifier module 120 may be part of the apparatus 100 or may be an external module connected to the apparatus 100.

The amplified radio frequency transmit signal 122 comprises at least two spectral clusters containing payload data to be transmitted to a receiver. The at least two spectral clusters may be allocated for data transmission during a given transmission time interval. Independent data streams may be transmitted by the at least two spectral clusters. The at least two spectral clusters may be located spectrally continuously (without spectral gap in between) or non-continuously (with spectral gap in between). For example, the at least two spectral clusters are generated due to intra-band carrier aggregation or multi-cluster transmission. For example, the at least two spectral clusters may represent component carriers of an intra-band carrier aggregation or an inter-band carrier aggregation. For example, the at least two spectral clusters may be LTE component carriers (e.g. LTE-20 carrier components comprising a band width of 20 MHz). The amplified radio frequency transmit signal 122 may be a signal within the radio frequency domain of a transmitter or transceiver comprising the apparatus 100. The amplified radio frequency transmit signal 122 may comprise signal portions containing payload data at frequencies between 400 MHz and 10 GHz, for example.

The control module 110 may enable a variation of an amplification characteristic of the power amplifier module by controlling at least one power amplifier stimulus. A power amplifier stimulus may be any power amplifier input signal and/or power amplifier supply quantity. For example, the power amplifier stimulus may be a power amplifier supply voltage, a power amplifier quiescent current or a pre-distortion of a radio frequency transmit signal provided to the power amplifier module for amplification. In other words, the control module may control a power amplifier supply voltage provided by a power supply module (e.g. DC-DC converter), a power amplifier quiescent current and/or a pre-distortion of a radio frequency transmit signal provided to the power amplifier module for amplification, for example. For example, the power amplifier quiescent current may be generated by a dedicated controller included in the power amplifier module and the quiescent current may be adjusted by an analog voltage applied to the PA module or by programming by means of a digital interface (e.g. MIPI RFFE bus, for example, defined by MIPI Alliance Specification for RF Front-End Control).

The control module 110 enables an adaptation of a power amplifier stimulus based on information related to at least one intermodulation product 102 caused during generation of an amplified radio frequency transmit signal 122. Intermodulation products may occur within the amplified radio frequency transmit signal 122 due to non-linear signal processing within the signal path of the transmit signal (e.g. signal path from a base band processor to an antenna module), for example. The power amplifier module 120 as well as other components of the signal path (e.g. antenna switch or matching network) may add undesired non-linear signal portions to the transmit signal.

The information related to at least one intermodulation product 102 may be or may relate to a center frequency, a power level and/or a bandwidth of the at least one intermodulation product, for example. The at least one intermodulation product may be a third order intermodulation product, for example. For example, the control module 110 may control the at least one power amplifier stimulus of a power amplifier module 120 based on information related to at least a third order intermodulation product caused during generation of the amplified radio frequency transmit signal. Third order intermodulation products may comprise higher power than other intermodulation products. However, in some cases other orders of intermodulation products may have a greater impact (e.g. due to the location of the higher order intermodulation product within the spectrum). Further, intermodulation products of different order may have an impact at the same time so that more than one intermodulation products may be considered by the control module 110 for controlling the at least one power amplifier stimulus, for example.

The center frequency, the power level and/or the bandwidth of the at intermodulation products within the amplified radio frequency transmit signal 122 may be calculable or predictable based on information (e.g. a number of resource blocks assigned to each spectral clusters, a distance between the spectral clusters, a cluster power of the spectral clusters) on the spectral clusters allocated for data transmission. For example, the apparatus 100 may comprise an optional calculation module for determining the information related to at least one intermodulation product 102. The calculation module may determine the information related to at least one intermodulation product 102 based on a number of resource blocks assigned to each spectral cluster of the amplified radio frequency transmit signal 122, a distance between the spectral clusters of the amplified radio frequency transmit signal 122, a cluster power of the spectral clusters of the amplified radio frequency transmit signal 122 and/or a model of the power amplifier module 120, for example.

Alternatively or additionally, the information related to at least one intermodulation product 102 may be determined based on the amplified radio frequency transmit signal 122. For example, the amplified radio frequency transmit signal 122 may be analyzed to identify intermodulation products and properties of the intermodulation products may be measured. For example, the apparatus 100 may comprise an optional feedback module determining the information related to at least one intermodulation product 102 based on the amplified radio frequency transmit signal. The feedback module may comprise a directional coupler within the transmit path (e.g. between the power amplifier module and an antenna module) for providing a radio frequency feedback signal proportional to the amplified radio frequency transmit signal 122 and a determining module for determining the information related to at least one intermodulation product 102 based on the feedback signal, for example.

The control module 110 may provide one or more control signals to one or more modules (e.g. power supply module and/or pre-distortion module) providing one or more power amplifier stimuli to the power amplifier module and/or may provide generate and provide one or more power amplifier stimuli (e.g. supply voltage or quiescent current) depending on the information related to at least one intermodulation product 102. For example, the apparatus 100 or the control module 110 may comprise a memory module configured to store a look-up table. The look-up table may comprise a plurality of possible control values for the at least one power amplifier stimulus corresponding to possible values of the information related to the at least one intermodulation product. The stored control values may correspond to signal levels of one or more control signals provided by the control module 110 or may correspond to different output levels of output quantities (e.g. supply voltage or quiescent current) of the control module 110. In other words, the input values of the look-up table may be information related to at least one intermodulation product 102 (e.g. input values related to a center frequency, a power level and/or a bandwidth of the at least one intermodulation product) and the output values of the look-up table may be signal levels of one or more control signals provided by the control module 110 to a component providing a power amplifier stimulus or may correspond to different output levels of an output quantity of the control module representing a power amplifier stimulus.

The control module 110 may trigger an adaptation of the at least one power amplifier stimulus for one or more predefined scenarios. An adaptation of the at least one power amplifier stimulus may be a change of the at least one power amplifier stimulus from a first setting (e.g. first supply voltage) to a different second setting (e.g. different second supply voltage). For example, the control module 110 may trigger an adaptation of the at least one power amplifier stimulus to adapt the linearity of the power amplifier module 120. The magnitude of intermodulation products may be influenced by adapting the linearity of the power amplifier module, for example 120.

For example, the control module 110 may trigger an adaptation of the at least one power amplifier stimulus, if at least one intermodulation product would be larger than a predefined limit without an adaptation. In other words, the control module 110 may trigger an adaptation of the at least one power amplifier stimulus, if the information related to the at least one intermodulation product indicates an excess of a predefined limit. The predefined limit may be defined in various ways. For example, the predefined limit may be an out of band emission limit, a spur emission limit, an Adjacent Channel Leakage Power Ratio limit, a spectrum emission mask limit or a receive band noise limit. For example, an out of band emission limit, a spur emission limit, an Adjacent Channel Leakage Power Ratio limit, a spectrum emission mask limit or a receive band noise limit may be defined by the wireless communication standard (e.g. LTE) used for data transmission. For example, out of band emission limits, spur emission limits and spectrum emission mask limits are defined in 3GPP Release 12 V12.6.0 (3GPP TS 36.101 V12.6.0).

For example, the control module 110 may trigger an increase of the power amplifier quiescent current, if the information related to the at least one intermodulation product indicates an excess of a predefined limit. For example, a spur emission limit, an Adjacent Channel Leakage Power Ratio limit, a spectrum emission mask limit or a receive band noise limit would be exceeded, if the at least one power amplifier stimulus is kept unchanged. An increase of the power amplifier quiescent current of the power amplifier module 120 may improve the linearity of the amplification of the radio frequency transmit signal 118. In this way, the magnitude of one or more intermodulation products may be reduced and the predefined limit may be kept.

Additionally, alternatively or optionally, the control module 110 may trigger a decrease or an increase of the power amplifier supply voltage, if the information related to the at least one intermodulation product indicates an excess of a predefined limit. An increase of the power amplifier supply voltage of the power amplifier module 120 may improve the linearity of the amplification of the radio frequency transmit signal 118. In this way, the magnitude of one or more intermodulation products may be reduced. Alternatively, a decrease of the power amplifier supply voltage of the power amplifier module 120 may reduce the output power capability of the power amplifier module 120. In this way, the amplitudes of all signal portions of the amplified radio frequency transmit signal 122 may be reduced resulting in a reduction of the magnitude of one or more intermodulation products as well, for example.

For example, the control module 120 may trigger an adaptation of the at least one power amplifier stimulus to increase an output power capability of the amplified radio frequency transmit signal taking into account predefined spectral limits (e.g. an out of band emission limit, a spur emission limit, an Adjacent Channel Leakage Power Ratio limit, a spectrum emission mask limit or a receive band noise limit) of a wireless communication standard used for transmission of the amplified radio frequency transmit signal. For example, the control module 120 may increase the power amplifier supply voltage to increase the output power. In more detail, the output power capability may be changed by means of supply voltage and/or quiescent current. The output itself may be changed by adjusting the average power of input signal 118, for example. For example, the control module 120 may trigger an increase of the output power capability so that the at least one intermodulation product is close (but still below) to a corresponding defined spectral limit of the used wireless communication standard. In this way, the transmit signal may be radiated with higher power while the spectral limits are still kept, for example.

Alternatively, the control module 110 may trigger an adaptation of the at least one power amplifier stimulus to decrease an output power capability of the amplified radio frequency transmit signal taking into account predefined maximum power reduction targets of a wireless communication standard used for transmission of the amplified radio frequency transmit signal. For example, the control module 120 may decrease the power amplifier supply voltage or the power amplifier quiescent current to decrease the output power (capability). For example, the control module 120 may trigger a decrease of the output power so that the output power is close to a maximum power reduction limit of the used wireless communication standard. In this way, the power consumption of a transmitter or receiver may be reduced while the transmit signal is still transmitted with sufficient power, for example.

Optionally, the control module 110 may trigger an adaptation of the at least one power amplifier stimulus to adapt the linearity of the power amplifier module 120 so that the power amplifier module 120 comprises a more linear behavior for a first amplified radio frequency transmit signal comprising a third order intermodulation product at a first distance (e.g. spectral distance between center frequency of closest cluster and intermodulation product) to a closest spectral cluster of the spectral clusters of the first amplified radio frequency transmit signal allocated for data transmission during a first time interval than for a second amplified radio frequency transmit signal comprising a third order intermodulation product at a second distance to a closest spectral cluster of the spectral clusters of the second amplified radio frequency transmit signal allocated for data transmission during a second time interval, if the first distance is larger than the second distance. In other words, the power amplifier stimulus may cause a better linearity of the power amplifier for center frequencies of the 3rd intermodulation products, which are farther away from the boundary frequencies of the assigned channel bandwidth relative to the 3rd order intermodulation products, which are closer to the boundary frequencies. In this way, third order intermodulation products located within the spurious emission domain (farther away) may be suppressed more efficiently than third order intermodulation products located within the out of band domain (closer), since the spurious emission domain comprises more strict boundaries than the out of band domain, for example.

Optionally, the apparatus 100 may comprise a radio frequency signal generation module (e.g. comprising a polar modulator or an inphase-quadratue phase modulator) configured to provide a radio frequency transmit signal to the power amplifier module based on a base band transmit signal (e.g. provided by a base band processor). Alternatively, an external frequency signal generation module may provide the radio frequency transmit signal to the power amplifier module.

The control module 110, the power amplifier module 120, the optional calculation module, the optional feedback module and/or the optional radio frequency signal generation module may be independent hardware units or part of a base band processor, a digital signal processor, a transmitter, a transceiver or a microcontroller or a computer program or a software product for running on a base band processor, a digital signal processor or a microcontroller, for example.

The apparatus 100 may be part of a transceiver or a transmitter or may represent a transceiver or a transmitter. For example, a corresponding transceiver or transmitter may transmit signals based on an LTE protocol or another protocol enabling carrier aggregation.

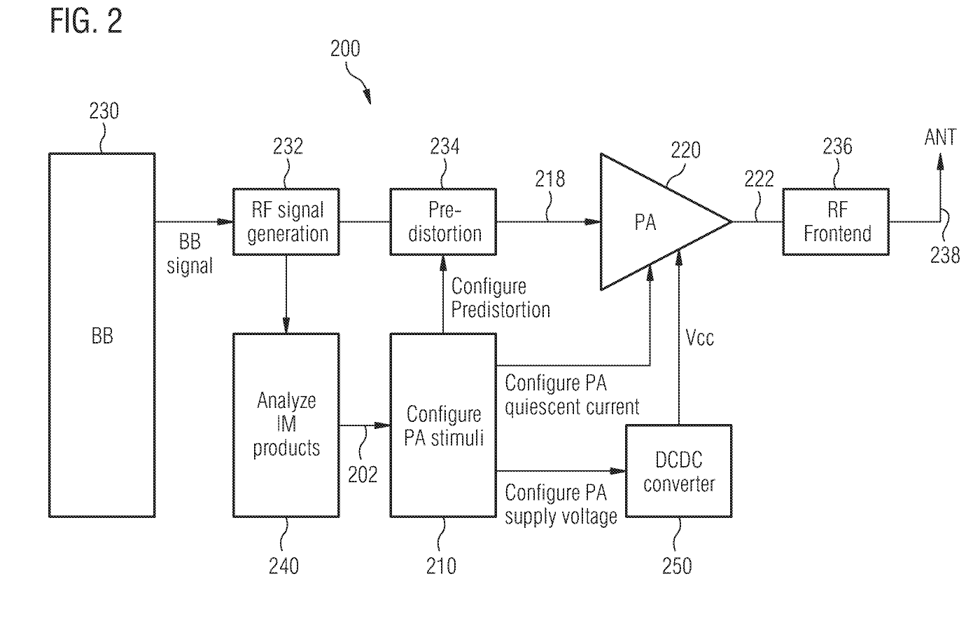

FIG. 2 shows a block diagram of a transmitter or transceiver with an apparatus for controlling the generation of a radio frequency transmit signal. The transmitter or transceiver 200 comprises a base band BB processor module 230 generating a base band BB signal and providing the base band signal to a radio frequency RF generation module 232. The radio frequency generation module 232 generates a radio frequency transmit signal based on the base band signal (e.g. by mixing the base band signal with a local oscillator signal). The radio frequency transmit signal is provided to a pre-distortion module 234 to generate a pre-distorted radio frequency transmit signal. Alternatively, the pre-distortion module 234 may be located between the base band processor module 230 and the radio frequency generation module 232. The pre-distorted radio frequency transmit signal 218 is provided to a power amplifier module 220 for amplification. The amplified radio frequency transmit signal 222 is provided to an antenna 238 via a radio frequency front end module 236 (e.g. matching network, filters and/or antenna switch) for transmission to an external receiver. Further, the transmitter or transceiver 200 comprises a power amplifier supply module 250 (e.g. DC-DC converter) generating an adjustable power amplifier supply voltage Vcc for the power amplifier module 220. The power amplifier supply module 250 may be an independent hardware module or part of the power amplifier module 220 or the control module 210.

Furthermore, the transmitter or transceiver 200 comprises a control module 210 for controlling or configuring one or more power amplifier PA stimuli based on information related to at least one intermodulation product 202. For example, the control module 210 is connected to the pre-distortion module 234 to control or configure the pre-distortion of the radio frequency transmit signal. Additionally or alternatively, the control module 210 is connected to the power amplifier module 220 to control or configure the power amplifier quiescent current, for example. Additionally or alternatively, the control module 210 is connected to the power amplifier supply module 250 to control or configure the power amplifier supply voltage, for example.

Additionally, the transmitter or transceiver 200 comprises a calculation module 240 for analyzing possible intermodulation IM products to provide information related to at least one intermodulation product 202 to the control module 210. The calculation module 240 may generate the information related to at least one intermodulation product 202 based on a signal provided by the radio frequency generation module 232 (e.g. the radio frequency transmit signal). Alternatively, the calculation module 240 may generate the information related to at least one intermodulation product 202 based on information (e.g. a number of resource blocks assigned to each spectral cluster of the amplified radio frequency transmit signal, a distance between the spectral clusters of the amplified radio frequency transmit signal, a cluster power of the spectral clusters of the amplified radio frequency transmit signal) provided by the base band processor module 230. The calculation module 240 may be an independent hardware module or part of the base band processor module 230 or the control module 210.

For example, multi-cluster transmission may be a severe issue due to the higher power of the intermodulation products. For example, in connection with mobile terminals, sophisticated implementations may heavily affect the user experience such as data throughput, talk time and RX (receiver) sensitivity. The intermodulation characteristic of a power amplifier (PA) may be strongly affected by changing the PA quiescent current and/or PA supply voltage, for example. A higher PA quiescent current may improve the high order intermodulation products (IM3, IM5 and beyond) but may increase PA current consumption and a higher quiescent current may degrade the legacy ACLR performance since PA linearity characteristic may behave differently for a contiguous spectrum or a clustered spectrum. The legacy ACLR characteristic of a contiguous spectrum might be for instance degraded by a higher PA quiescent current. Here PA quiescent current and PA supply voltage may be selected such that the PA AMAM-(amplitude to amplitude) and AMPM (amplitude to phase) response are linearized. However this may mainly work for contiguous spectrum and might degrade intermodulation characteristic of a clustered signal. According to an aspect, the knowledge of harmful intermodulation products may give guidance how to configure the PA stimuli given by PA quiescent current, PA supply voltage and/or pre-distortion characteristic.

According to an aspect, the multi-cluster signal is analyzed (e.g. by means of the cluster sizes, gaps between clusters and cluster power). These inputs can be used to calculate the intermodulation products; more precisely the location of the intermodulation products (frequency wise), the estimated power of the intermodulation products (IM power) and/or the size/bandwidth of the IM products, for example.

In a next steps it may be analyzed if the location and the expected power of the intermodulation product is critical for ACLR (e.g. UTRA2), SEM, noise in RX or other known critical cases, for example. This step may be called IM analysis (intermodulation analysis).

For example, if IM analysis does not indicate harmful IM products the PA stimuli can be configured for best PA current consumption at a given MPR (maximum power reduction) target or the MPR value can be reduced to a minimum value in order to maximize power and thus data throughput. The decision to minimize battery current or to maximize power may be customer dependent.

For example, if frequency location and power of a certain intermodulation product may be harmful for a certain 3GPP test case or noise in RX band then the PA stimuli may be configured to improve the critical intermodulation product and potentially the MPR figure may be set to a maximum value (e.g. in accordance with wireless standard e.g. 3GPP TS 36.101) in order to minimize the IM level.

More details and aspects of the transmitter or transceiver 200 are mentioned in connection with the proposed concept or one or more examples described above or below (e.g. FIG. 1). The transmitter or transceiver 200 may comprise one or more additional optional features corresponding to one or more aspects of the proposed concept or one or more examples described above or below.

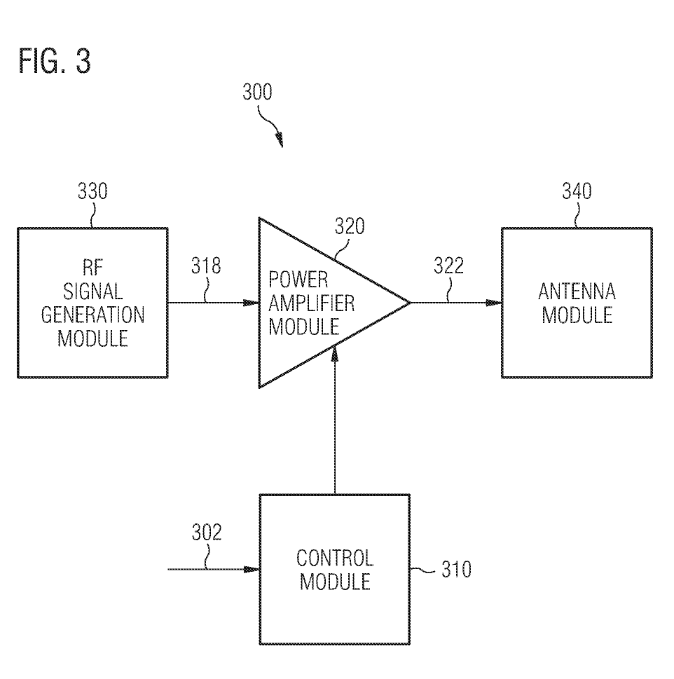

FIG. 3 shows a block diagram of an apparatus for controlling the generation of a radio frequency transmit signal. The apparatus 300 comprises a control module 310. The control module 310 controls at least one power amplifier stimulus of a power amplifier module 320 based on input data 302 usable for determining information related to at least one intermodulation product caused during generation of an amplified radio frequency transmit signal 322 amplified by the power amplifier module 320. The amplified radio frequency transmit signal 322 comprises at least two spectral clusters. Further, the at least one power amplifier stimulus is one of the group of a power amplifier supply voltage, a power amplifier quiescent current and a pre-distortion of a radio frequency transmit signal 318 provided to the power amplifier module 320 for amplification. Additionally, the control module 310 triggers an adaptation of the at least one power amplifier stimulus, if the information related to the at least one intermodulation product indicates an excess of a predefined limit.

The linearity and/or output power of the power amplifier module may be varied by adapting a power amplifier stimulus of the power amplifier module. In this way, the magnitude of intermodulation products within RF transmit signals may be controlled. Further, predefined spectral limits (e.g. of a wireless communication standard) may be kept easier and/or more accurate. Further, the current consumption or data throughput may be improved.

The input data 302 may be information known before transmission of the RF transmit signal (e.g. frequencies, clusters, resource blocks and/or bandwidths to be used). For example, the input data 302 may be a number of resource blocks assigned to each spectral cluster of the amplified radio frequency transmit signal 322, a distance between the spectral clusters of the amplified radio frequency transmit signal 322 and/or a cluster power of the spectral clusters of the amplified radio frequency transmit signal 322.

The input data 302 is useable to determine information related to at least one intermodulation product, although a real time determination of the information related to at least one intermodulation product may be avoided, since information related to at least one intermodulation product may be pre-calculated and control values corresponding to a plurality of different combinations of possible values of the input data may be stored by a look-up table. In this way, the calculation efforts within a transmitter or transceiver may be reduced.

For example, the apparatus 300 or the control module 310 may comprise a memory module storing a look-up table. The look-up table may comprises a plurality of possible control values for an adaptation of the at least one power amplifier stimulus corresponding to possible values of the input data 302 usable for determining the information related to the at least one intermodulation product.

More details and aspects (e.g. regarding the power amplifier module, the amplified radio frequency transmit signal, the radio frequency transmit signal provided to the power amplifier module, information related to the at least one intermodulation product and/or the predefined limit) of the apparatus 300 are mentioned in connection with the proposed concept or one or more examples described above or below (e.g. FIG. 1). The apparatus 300 may comprise one or more additional optional features corresponding to one or more aspects of the proposed concept or one or more examples described above or below.

Some examples relate to an apparatus for controlling the generation of a radio frequency transmit signal. The apparatus comprises means for controlling configured to control at least one power amplifier stimulus of means for amplifying based on information related to at least one intermodulation product caused during generation of an amplified radio frequency transmit signal amplified by the means for amplifying. The amplified radio frequency transmit signal comprises at least two spectral clusters allocated for data transmission.

The means for controlling may be implemented by a control module described above or below (e.g. FIG. 1) and the means for amplifying may be implemented by a power amplifier module described above or below (e.g. FIG. 1).

The apparatus may comprise one or more additional optional features corresponding to one or more aspects of the proposed concept or one or more examples described above or below.

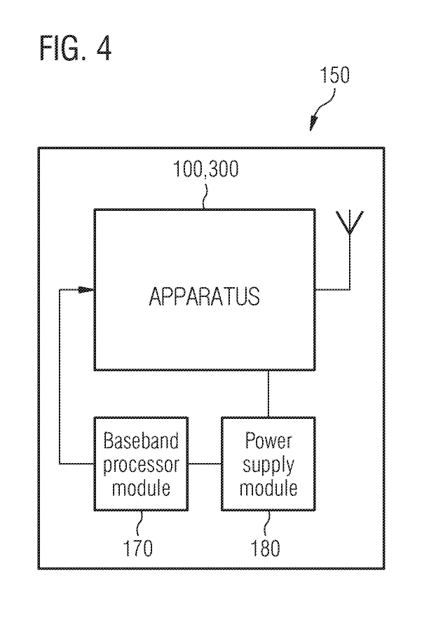

FIG. 4 shows a schematic illustration of a mobile device 150. The mobile device 150 comprises an apparatus 100, 300 (e.g. FIG. 1 or 3) controlling the generation of a radio frequency transmit signal within a transmitter or a transceiver (e.g. FIG. 2). Further, the mobile device 150 comprises a baseband processor module 170 generating a baseband signal, which is used to generate the radio frequency transmit signal. Additionally, the mobile device 150 comprises a power supply unit 180 supplying at least the transmitter or the transceiver and the baseband processor module 170 with power.

More details and aspects of an apparatus for controlling the generation of a radio frequency transmit signal within a transmitter or a transceiver are mentioned in connection with the proposed concept or one or more examples described above (e.g. FIG. 1-3). The mobile device 150 may comprise one or more additional optional features corresponding to one or more aspects of the proposed concept or one or more examples described above or below.

In some examples, a cell phone may comprise a transmitter or a transceiver comprising an apparatus for controlling the generation of a radio frequency transmit signal according to the proposed concept or one or more examples described above or below.

Further, some examples relate to a base station or a relay station of a mobile communication system comprising a transmitter or a transceiver with an apparatus for controlling the generation of a radio frequency transmit signal according to the described concept or one or more examples described above or below.

Some examples relate to a wireless communication system comprising at least one base station and at least one mobile device as described above or below. The mobile device (e.g. FIG. 4) is configured to transmit the amplified radio frequency transmit signal to the base station.

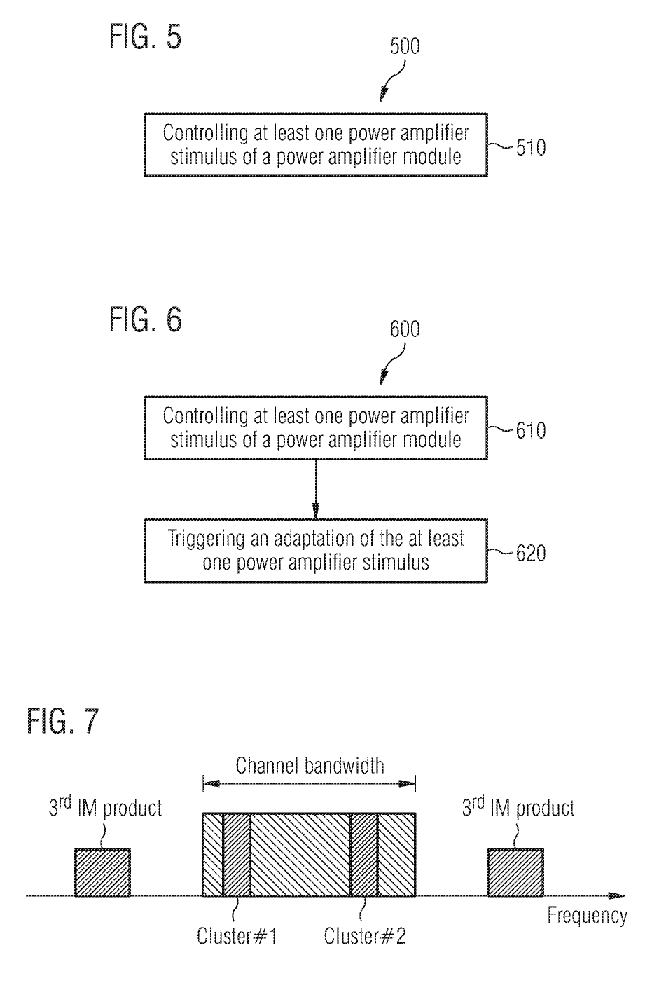

FIG. 5 shows a flow chart of a method for controlling the generation of a radio frequency transmit signal. The method 500 comprises controlling 510 at least one power amplifier stimulus of a power amplifier module based on information related to at least one intermodulation product caused during generation of an amplified radio frequency transmit signal amplified by the power amplifier module. The amplified radio frequency transmit signal comprises at least two spectral clusters allocated for data transmission.

More details and aspects of the method 500 are mentioned in connection with the proposed concept or one or more examples described above or below (e.g. FIG. 1-4). The method 500 may comprise one or more additional optional features corresponding to one or more aspects of the proposed concept or one or more examples described above or below.

FIG. 6 shows a flow chart of a method for controlling the generation of a radio frequency transmit signal. The method 600 comprises controlling 610 at least one power amplifier stimulus of a power amplifier module based on input data usable for determining information related to at least one intermodulation product caused during generation of an amplified radio frequency transmit signal amplified by the power amplifier module. The amplified radio frequency transmit signal comprises at least two spectral clusters. Further, the at least one power amplifier stimulus is one of the group of a power amplifier supply voltage, a power amplifier quiescent current and a pre-distortion of a radio frequency transmit signal provided to the power amplifier module for amplification. Additionally, the method 600 comprises triggering 620 an adaptation of the at least one power amplifier stimulus, if the information related to the at least one intermodulation product indicates an excess of a predefined limit.

More details and aspects of the method 600 are mentioned in connection with the proposed concept or one or more examples described above or below (e.g. FIG. 1-4). The method 600 may comprise one or more additional optional features corresponding to one or more aspects of the proposed concept or one or more examples described above or below.

Some examples relate to a method for optimizing the performance of a wireless terminal for multi-cluster signals.

For example, a method may be proposed, which minimizes the power reduction and optimizes the PA current consumption depending on cluster size (number of RBs assigned to each cluster), gaps between the clusters and cluster power.

According to an aspect, a multi-cluster may be analyzed and the frequency location, the estimated power and the bandwidth of the intermodulation products caused by the clustered RF signal may be determined.

Depending on severity of an intermodulation product characterized by at least center frequency, power or bandwidth of the intermodulation product the PA stimuli (quiescent current, supply voltage, pre-distortion) may be configured to meet the relevant 3GPP requirements applicable at the frequency points of at least the IM3 products, for example.

The PA stimuli may be configured either to maximize the output power still keeping 3GPP limits (e.g. for SEM) or to minimize the current consumption for a given 3GPP MPR target. The configuration target may be customer dependent and thus enables customization.

According to an aspect, the PA stimuli may be changed either to save current or to maximize the output power (=minimize MPR value). The described concept may apply to the full power range whereas any MPR procedure may only be applicable to the maximum output power. Below the maximum output power (no MPR allowed) a clever management of the PA stimuli may be used for superior performance. MPR=Maximum Power Reduction is a 3GPP feature which allows to reduce the maximum output power in order pass critical 3GPP RF test cases, for example.

Some examples relate to a radio communication device comprising a power amplifier circuitry generating a RF output signal in response to a RF input signal, a DCDC converter generating an output voltage to supply the power amplifier, a control unit controlling the output power level of the power amplifier, the quiescent current setting of the power amplifier, the supply voltage of the power amplifier and/or the pre-distortion characteristic of the input signal of the power amplifier, a RF signal generation unit connected to the input of the power amplifier configured to generate a RF signal with at least two spectral clusters within the assigned channel bandwidth, means to calculate the center frequencies, the power levels of the intermodulation products and/or the size of the intermodulation products at the output of the power amplifier caused by the spectral clusters, wherein the control unit is configured to set the PA supply voltage, the PA quiescent current and/or the pre-distortion characteristic of the input signal to the power amplifier in response to the center frequencies, the power of the intermodulation products and the size of the intermodulation products.

For example, the radio communication device is configured to calculate at least 3rd order intermodulation products of the spectral clusters.

Some examples relate to a method for configuring the stimuli of a power amplifier by analyzing the intermodulation characteristic of a multi-cluster RF signal, wherein the intermodulation characteristic of the multi-cluster signal at the output of a power amplifier is given by the center frequencies of the intermodulation products relative to the boundary frequencies of an assigned channel bandwidth, the bandwidth of the intermodulation products and/or the estimated power levels of the intermodulation products.

For example, the power amplifier stimuli may be at least given by the PA quiescent current, the PA supply voltage or the pre-distortion characteristic of the input signal of the power amplifier.

Optionally, the power amplifier stimuli may be configured depending on the frequency distance between the center frequencies of the 3rd intermodulation products, the boundary frequencies of an assigned channel bandwidth and a MPR target.

For example, the MPR value may be configured between a maximum value allowed by corresponding 3GPP standards in order to minimize the current consumption of the power amplifier and a minimum value to maximize the PA output power and thus data throughput depending on the overall system optimization targets.

For example, the power amplifier stimuli may be configured for providing a better linearity of the power amplifier if the center frequencies of the 3rd intermodulation products are farther away from the boundary frequencies of the assigned channel bandwidth relative to the 3rd order intermodulation products which are closer to the boundary frequencies.

Optionally, a linearity of the power amplifier may be improved by either increasing the PA quiescent or the PA supply voltage or both.

According to an aspect, the power amplifier stimuli may be configured depending on the estimated power levels of the 3rd order intermodulation products relative to the spurious emissions limits given by applicable wireless standard.

Optionally, the power levels of the intermodulation products may be estimated depending on the power levels of each spectral cluster, the size of each spectral cluster and a PA model describing at least an IP3 characteristic of the power amplifier.

Further optionally, the power amplifier stimuli may be configured for providing a better linearity of the power amplifier if the estimated power levels of the 3rd order intermodulation products have less than a pre-defined margin relative to the spurious emissions limits at the frequencies of the 3rd order intermodulation products given by the applicable wireless standard.

Some examples relate to an implementation of the proposed concept in high volume architectures, in computer system architectures features and interfaces made in high volumes, may encompass IA (integrated architectures), devices (e.g. transistors) and associated manufacturing (mfg) processes.

In the following further examples are mentioned. Example 1 is apparatus for controlling the generation of a radio frequency transmit signal, wherein the apparatus comprises a control module configured to control at least one power amplifier stimulus of a power amplifier module based on information related to at least one intermodulation product caused during generation of an amplified radio frequency transmit signal amplified by the power amplifier module, wherein the amplified radio frequency transmit signal comprises at least two spectral clusters allocated for data transmission.

In example 2, the subject matter of example 1 can optionally include the control module being configured to control the at least one power amplifier stimulus of a power amplifier module based on information related to at least a third order intermodulation product caused during generation of the amplified radio frequency transmit signal.

In example 3, the subject matter of example 1 or 2 can optionally include the at least two spectral clusters being intra-band carrier aggregation clusters or inter-band carrier aggregation clusters.

In example 4, the subject matter of any one of examples 1-3 can optionally include the control module being configured to control a power amplifier quiescent current.

In example 5, the subject matter of any one of examples 1-4 can optionally include the control module being configured to control a power amplifier supply voltage.

In example 6, the subject matter of any one of examples 1-5 can optionally include the control module being configured to control a pre-distortion of a radio frequency transmit signal provided to the power amplifier module for amplification.

In example 7, the subject matter of any one of examples 1-6 can optionally include the information related to at least one intermodulation product comprising at least one of a center frequency, a power level and a bandwidth of the at least one intermodulation product.

In example 8, the subject matter of any one of examples 1-7 can optionally include a calculation module configured to determine the information related to at least one intermodulation product based on at least one of a number of resource blocks assigned to each spectral clusters of the amplified radio frequency transmit signal, a distance between the spectral clusters of the amplified radio frequency transmit signal, a cluster power of the spectral clusters of the amplified radio frequency transmit signal and a model of the power amplifier module.

In example 9, the subject matter of any one of examples 1-8 can optionally include a feedback module configured to determine the information related to at least one intermodulation product based on the amplified radio frequency transmit signal.

In example 10, the subject matter of any one of examples 1-9 can optionally include comprising a memory module configured to store a look-up table, wherein the look-up table comprises a plurality of possible control values for the at least one power amplifier stimulus corresponding to possible values of the information related to the at least one intermodulation product.

In example 11, the subject matter of one of the previous examples can optionally include the control module being configured to trigger an adaptation of the at least one power amplifier stimulus, if the information related to the at least one intermodulation product indicates an excess of a predefined limit.

In example 12, the subject matter of example 11 can optionally include the predefined limit being at least one of an out of band emission limit, a spur emission limit, an Adjacent Channel Leakage Power Ratio limit, a spectrum emission mask limit or a receive band noise limit.

In example 13, the subject matter of any of the previous examples can optionally include the control module being configured to trigger an increase of the power amplifier quiescent current, if the information related to the at least one intermodulation product indicates an excess of a predefined limit.

In example 14, the subject matter of any of the previous examples can optionally including the control module being configured to trigger a decrease or an increase of the power amplifier supply voltage, if the information related to the at least one intermodulation product indicates an excess of a predefined limit.

In example 15, the subject matter of any one of any of the previous examples can optionally include the control module being configured to trigger an adaptation of the at least one power amplifier stimulus to increase an output power capability of the amplified radio frequency transmit signal taking into account predefined spectral limits of a wireless communication standard used for transmission of the amplified radio frequency transmit signal.

In example 16, the subject matter of any of the previous examples can optionally include the control module being configured to trigger an adaptation of the at least one power amplifier stimulus to decrease an output power capability of the amplified radio frequency transmit signal taking into account predefined maximum power reduction targets of a wireless communication standard used for transmission of the amplified radio frequency transmit signal.

In example 17, the subject matter of any of the previous examples can optionally include the control module being configured to trigger an adaptation of the at least one power amplifier stimulus to adapt the linearity of the power amplifier module.

In example 18, the subject matter of example 17 can optionally include the control module being configured to trigger an adaptation of the at least one power amplifier stimulus to adapt the linearity of the power amplifier module so that the power amplifier module comprises a more linear behavior for a first amplified radio frequency transmit signal comprising a third order intermodulation product at a first distance to a closest spectral cluster of the spectral clusters of the first amplified radio frequency transmit signal allocated for data transmission during a first time interval than for a second amplified radio frequency transmit signal comprising a third order intermodulation product at a second distance to a closest spectral cluster of the spectral clusters of the second amplified radio frequency transmit signal allocated for data transmission during a second time interval, wherein the first distance is larger than the second distance.

In example 19, the subject matter of any one of examples 1-18 can optionally include a radio frequency signal generation module configured to provide a radio frequency transmit signal to the power amplifier module based on a base band transmit signal.

Example 20 is an apparatus for controlling the generation of a radio frequency transmit signal, wherein the apparatus comprises a control module configured to control at least one power amplifier stimulus of a power amplifier module based on input data usable for determining information related to at least one intermodulation product caused during generation of an amplified radio frequency transmit signal amplified by the power amplifier module, wherein the amplified radio frequency transmit signal comprises at least two spectral clusters, wherein the at least one power amplifier stimulus is one of the group of a power amplifier supply voltage, a power amplifier quiescent current and a pre-distortion of a radio frequency transmit signal provided to the power amplifier module for amplification, wherein the control module is configured to trigger an adaptation of the at least one power amplifier stimulus, if the information related to the at least one intermodulation product indicates an excess of a predefined limit.

In example 21, the subject matter of example 20 can optionally include a memory module configured to store a look-up table, wherein the look-up table comprises a plurality of possible control values for an adaptation of the at least one power amplifier stimulus corresponding to possible values of the input data usable for determining the information related to the at least one intermodulation product.

Example 22 is an apparatus for controlling the generation of a radio frequency transmit signal, wherein the apparatus comprises means for controlling configured to control at least one power amplifier stimulus of means for amplifying based on information related to at least one intermodulation product caused during generation of an amplified radio frequency transmit signal amplified by the means for amplifying, wherein the amplified radio frequency transmit signal comprises at least two spectral clusters allocated for data transmission.

In example 23, the subject matter of example 22 can optionally include the means for controlling being configured to control the at least one power amplifier stimulus of the means for amplifying based on information related to at least a third order intermodulation product caused during generation of the amplified radio frequency transmit signal.

Example 24 is a transmitter or a transceiver comprising an apparatus according the subject matter of any of the previous examples.

In example 25, the subject matter of example 24 can optionally be configured to transmit signals based on an LTE protocol or another protocol enabling carrier aggregation.

Example 26 is a mobile device comprising a transmitter or a transceiver according to example 24 or 25.

Example 27 is wireless communication system comprising at least one base station and at least one mobile device according to example 26, wherein the mobile device is configured to transmit the amplified radio frequency transmit signal to the base station.

Example 28 is a method for controlling the generation of a radio frequency transmit signal, wherein the method comprises controlling at least one power amplifier stimulus of a power amplifier module based on information related to at least one intermodulation product caused during generation of an amplified radio frequency transmit signal amplified by the power amplifier module, wherein the amplified radio frequency transmit signal comprises at least two spectral clusters allocated for data transmission.

In example 29, the subject matter of example 28 can optionally include controlling the at least one power amplifier stimulus of a power amplifier module is based on information related to at least a third order intermodulation product caused during generation of the amplified radio frequency transmit signal.

In example 30, the subject matter of example 28 or 29 can optionally include the at least two spectral clusters are intra-band carrier aggregation clusters or inter-band carrier aggregation clusters.

In example 31, the subject matter of one of the examples 28 to 30 can optionally include the at least one power amplifier stimulus being a power amplifier supply voltage.

In example 32, the subject matter of one of the examples 28 to 31 can optionally include the at least one power amplifier stimulus being a power amplifier quiescent current.

In example 33, the subject matter of one of the examples 28 to 32 can optionally include the at least one power amplifier stimulus being a pre-distortion of a radio frequency transmit signal provided to the power amplifier module for amplification.

In example 34, the subject matter of one of the examples 28 to 33 can optionally include the information related to at least one intermodulation product comprising at least one of a center frequency, a power level and a bandwidth of the at least one intermodulation product.

In example 35, the subject matter of one of the examples 28 to 34 can optionally include determining the information related to at least one intermodulation product based on at least one of a number of resource blocks assigned to each spectral clusters of the amplified radio frequency transmit signal, a distance between the spectral clusters of the amplified radio frequency transmit signal, a cluster power of the spectral clusters of the amplified radio frequency transmit signal and a model of the power amplifier module.

In example 36, the subject matter of one of the examples 28 to 35 can optionally include determining the information related to at least one intermodulation product based on the amplified radio frequency transmit signal.

In example 37, the subject matter of one of the examples 28 to 36 can optionally include storing a look-up table, wherein the look-up table comprises a plurality of possible control values for the at least one power amplifier stimulus corresponding to possible values of the information related to the at least one intermodulation product.

Example 38 is a method for controlling the generation of a radio frequency transmit signal, wherein the method comprises controlling at least one power amplifier stimulus of a power amplifier module based on input data usable for determining information related to at least one intermodulation product caused during generation of an amplified radio frequency transmit signal amplified by the power amplifier module, wherein the amplified radio frequency transmit signal comprises at least two spectral clusters, wherein the at least one power amplifier stimulus is one of the group of a power amplifier supply voltage, a power amplifier quiescent current and a pre-distortion of a radio frequency transmit signal provided to the power amplifier module for amplification and triggering an adaptation of the at least one power amplifier stimulus, if the information related to the at least one intermodulation product indicates an excess of a predefined limit.

In example 39, the subject matter of example 38 can optionally include comprising storing a look-up table, wherein the look-up table comprises a plurality of possible control values for an adaptation of the at least one power amplifier stimulus corresponding to possible values of the input data usable for determining the information related to the at least one intermodulation product.

Example 39 is a machine readable storage medium including program code, when executed, to cause a machine to perform the method of one of the examples 28 or 38.

Example 40 is a machine readable storage including machine readable instructions, when executed, to implement a method or realize an apparatus as implemented by any one of examples 1-39.

Example 41 is a computer program having a program code for performing the method of one of the examples 28 or 38, when the computer program is executed on a computer or processor.

Examples may further provide a computer program having a program code for performing one of the above methods, when the computer program is executed on a computer or processor. A person of skill in the art would readily recognize that steps of various above-described methods may be performed by programmed computers. Herein, some examples are also intended to cover program storage devices, e.g., digital data storage media, which are machine or computer readable and encode machine-executable or computer-executable programs of instructions, wherein the instructions perform some or all of the acts of the above-described methods. The program storage devices may be, e.g., digital memories, magnetic storage media such as magnetic disks and magnetic tapes, hard drives, or optically readable digital data storage media. The examples are also intended to cover computers programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. It will thus be appreciated that those skilled in the art will be able to devise various arrangements that, although not explicitly described or shown herein, embody the principles of the disclosure and are included within its spirit and scope. Furthermore, all examples recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions. Moreover, all statements herein reciting principles, aspects, and examples of the disclosure, as well as specific examples thereof, are intended to encompass equivalents thereof.

Functional blocks denoted as “means for . . . ” (performing a certain function) shall be understood as functional blocks comprising circuitry that is configured to perform a certain function, respectively. Hence, a “means for s.th.” may as well be understood as a “means configured to or suited for s.th.”. A means configured to perform a certain function does, hence, not imply that such means necessarily is performing the function (at a given time instant).

Functions of various elements shown in the figures, including any functional blocks labeled as “means”, “means for providing a sensor signal”, “means for generating a transmit signal.”, etc., may be provided through the use of dedicated hardware, such as “a signal provider”, “a signal processing unit”, “a processor”, “a controller”, etc. as well as hardware capable of executing software in association with appropriate software. Moreover, any entity described herein as “means”, may correspond to or be implemented as “one or more modules”, “one or more devices”, “one or more units”, etc. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

It should be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Furthermore, the following claims are hereby incorporated into the Detailed Description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are proposed herein unless it is stated that a specific combination is not intended. Furthermore, it is intended to include also features of a claim to any other independent claim even if this claim is not directly made dependent to the independent claim.

It is further to be noted that methods disclosed in the specification or in the claims may be implemented by a device having means for performing each of the respective acts of these methods.

Further, it is to be understood that the disclosure of multiple acts or functions disclosed in the specification or claims may not be construed as to be within the specific order. Therefore, the disclosure of multiple acts or functions will not limit these to a particular order unless such acts or functions are not interchangeable for technical reasons. Furthermore, in some examples a single act may include or may be broken into multiple sub acts. Such sub acts may be included and part of the disclosure of this single act unless explicitly excluded.

What is claimed is:

1. An apparatus for controlling the generation of a radio frequency transmit signal comprising:
a power amplifier module configured to amplify a radio frequency transmit signal; and
a control module configured to control at least one power amplifier stimulus of the power amplifier module based on information related to at least one intermodulation product generated during generation of an amplified radio frequency transmit signal, wherein the amplified radio frequency transmit signal comprises at least two spectral clusters allocated for data transmission.

2. The apparatus according to claim 1, wherein the control module is configured to control the at least one power amplifier stimulus of the power amplifier module based on information related to at least a third order intermodulation product caused during generation of an amplified radio frequency transmit signal.

3. The apparatus according to claim 1, wherein the at least two spectral clusters are generated due to intra-band carrier aggregation or multi-cluster transmission.

4. The apparatus according to claim 1, wherein the control module is configured to control a power amplifier supply voltage.

5. The apparatus according to claim 1, wherein the control module is configured to control a power amplifier quiescent current.

6. The apparatus according to claim 1, wherein the control module is configured to control a pre-distortion of a radio frequency transmit signal provided to the power amplifier module for amplification.

7. The apparatus according to claim 1, wherein the information related to at least one intermodulation product comprises at least one of a center frequency, a power level, and a bandwidth of the at least one intermodulation product.

8. The apparatus according to claim 1, comprising a calculation module configured to determine the information related to at least one intermodulation product based on at least one of a number of resource blocks assigned to each spectral cluster of the amplified radio frequency transmit signal, a distance between the spectral clusters of the amplified radio frequency transmit signal, a cluster power of the spectral clusters of the amplified radio frequency transmit signal and a model of the power amplifier module.

9. The apparatus according to claim 1, comprising a feedback module configured to determine the information related to at least one intermodulation product based on the amplified radio frequency transmit signal.

10. The apparatus according to claim 1, comprising a memory module configured to store a look-up table, wherein the look-up table comprises a plurality of possible control values for the at least one power amplifier stimulus corresponding to possible values of the information related to the at least one intermodulation product.

11. The apparatus according to claim 1, wherein the control module is configured to trigger an adaptation of the at least one power amplifier stimulus, if the information related to the at least one intermodulation product indicates an excess of a predefined limit.

12. The apparatus according to claim 11, wherein the predefined limit is at least one of an out of band emission limit, a spur emission limit, an Adjacent Channel Leakage Power Ratio limit, a spectrum emission mask limit or a receive band noise limit.

13. The apparatus according to claim 1, wherein the control module is configured to trigger an increase of the power amplifier quiescent current, if the information related to the at least one intermodulation product indicates an excess of a predefined limit.

14. The apparatus according to claim 1, wherein the control module is configured to trigger a decrease or an increase of the power amplifier supply voltage, if the information related to the at least one intermodulation product indicates an excess of a predefined limit.

15. The apparatus according to claim 1, wherein the control module is configured to trigger an adaptation of the at least one power amplifier stimulus to increase an output power capability of the amplified radio frequency transmit signal taking into account predefined spectral limits of a wireless communication standard used for transmission of the amplified radio frequency transmit signal.

16. The apparatus according to claim 1, wherein the control module is configured to trigger an adaptation of the at least one power amplifier stimulus to decrease an output power capability of the amplified radio frequency transmit signal taking into account predefined maximum power reduction targets of a wireless communication standard used for transmission of the amplified radio frequency transmit signal.

17. An apparatus for controlling the generation of a radio frequency transmit signal, wherein the apparatus comprises a control module configured to control at least one power amplifier stimulus of a power amplifier module based on input data usable for determining information related to at least one intermodulation product caused during generation of an amplified radio frequency transmit signal amplified by the power amplifier module, wherein the amplified radio frequency transmit signal comprises at least two spectral clusters,
wherein the at least one power amplifier stimulus is one of the group of a power amplifier supply voltage, a power amplifier quiescent current and a pre-distortion of a radio frequency transmit signal provided to the power amplifier module for amplification,
wherein the control module is configured to trigger an adaptation of the at least one power amplifier stimulus, if the information related to the at least one intermodulation product indicates an excess of a predefined limit.

18. The apparatus according to claim 17, comprising a memory module configured to store a look-up table, wherein the look-up table comprises a plurality of possible control values for an adaptation of the at least one power amplifier stimulus corresponding to possible values of the input data usable for determining the information related to the at least one intermodulation product.

19. A method for controlling the generation of a radio frequency transmit signal, wherein the method comprises controlling at least one power amplifier stimulus of a power amplifier module based on information related to at least one intermodulation product generated during generation of an amplified radio frequency transmit signal, wherein the amplified radio frequency transmit signal comprises at least two spectral clusters allocated for data transmission.
